(19) United States
(12) Patent Application Publication
(10) Pub. No.: US 2013/0206473 A1
(43) Pub. Date: Aug. 15, 2013

(54) Electrical Connection System for an Energy Generation Device

(71) Applicants: Heinz-Georg Gottschlich, Erkelenz (DE); Martin Schloms, Aachen (DE); Franz-Josef Lietz, Oberhausen-Lirich (DE)

(72) Inventors: Heinz-Georg Gottschlich, Erkelenz (DE); Martin Schloms, Aachen (DE); Franz-Josef Lietz, Oberhausen-Lirich (DE)

(73) Assignee: AUTO KABEL MANAGEMENTGESELLSCHAFT MBH, Hausen i.W. (DE)

(21) Appl. No.: 13/820,805

(22) PCT Filed: Sep. 20, 2011
(86) PCT No.: PCT/EP11/66268

§ 371 Date: Mar. 29, 2013

(30) Foreign Application Priority Data
Sep. 21, 2010 (DE) 102010045921.6-34

(51) Int. Cl. H02G 15/00

(52) U.S. Cl. CPC H02G 15/00
USPC 174/75 R

(57) ABSTRACT

Electrical connection system for an energy generation device 2 having a first connector 18 disposed at one end of a first cable 10a, and a second connector 28 that is disposed at one end of a second cable 10b or a second end of the first cable 10a and is complementary to the first connector 18. A particularly simple assembly is ensured in that the second connector 28 is a pin 30 to be disposed in the receptacle 24 in a self-locking manner.

The subject matter relates to an electrical connection system of an energy generation device within a first connector disposed at one end of a first cable, and a second connector disposed at one end of a second cable and that is complementary to the first connector. The subject matter further relates to a method for connecting cables in electrical connection systems of energy generation devices.

Electrical energy generation devices, such as, for example, wind power systems, are nowadays fitted with copper or aluminium cables. Because of rising copper prices fitting out with aluminium cables is becoming increasingly common, however. With wind power systems in particular, which are between 50 m and 150 m tall, large quantities of cables are required, so that the savings potential of aluminium cables is considerable.

Because of the great height of wind power systems, however, it is impossible to connect the generators disposed in the tower of the wind power system by means of a single cable with the converter disposed in the base of the system. Therefore cables are preinstalled in each individual tower segment. In order to connect the cables of the individual segments together, these must have an electrically conducting screw or crimped connection at the limits of the segments. As long as copper cables are used, crimping or screwing of the cable is unproblematic, since the surface of the copper is not subject to any deposits of material having a negative effect on the electrical conductivity which during the period of operation of the wind power system could lead to a reduction in the electrical conductivity of the connection. Where aluminium cables are used this is not the case, however. A crimped connection must be protected from environmental influences. Aluminium oxide must also be prevented from forming on the transitions and considerably increasing the contact resistance. Where cables carry in excess of 10 A or even in excess of 100 A, an electrical contact resistance is always associated with a high power loss. It is therefore necessary to seek to make the electrical contact resistance between the cables at the connection point as low as possible.

These days, therefore, crimping at the section limits of the cables of the respective sections is proposed. For this a crimp barrel is screwed onto the cable. For this the engineer has to climb into the tower, out the cable to length and strip the insulation at the section limits. Then the engineer must coat the stripped ends of the cable with a conductive paste. This prevents aluminium oxide forming on the surfaces of the aluminium strands. Then the engineer must slide the crimp barrel onto the free cable ends and in a complicated process involving many screws screw these to the cables. The assembly described is time-consuming and cost-intensive. In addition, the quality of the electrical connection is not stable, meaning that over time the electrical contact resistance increases, since the conductive paste cannot fully prevent the formation of aluminium oxide.

For this reason the object for the subject-matter was to provide an electrical connection system for an energy generation device, which is particularly easy to assemble.

This object is achieved according to the subject-matter by a connection system according to claim 1.

It has been recognised that crimping and screwing of aluminium cable is prone to error and does not allow a sufficiently low contact resistance to be achieved. It has also been recognised that the known assembly method is too time-consuming. It is therefore proposed that the respective cable ends are provided with a receptacle and a corresponding pin, which can be located one inside the other. The pin is designed in such as way that it can be disposed in the receptacle in a self-locking manner.

Self-locking can be understood to mean that the static friction of the pin in the receptacle offers a resistance against axial slip or rotation of the pin in the receptacle. Here the angle of inclination and the surface roughness of the pin and of the receptacle are varied such that the self-locking is sufficiently great that the tensile force of the cable acting axially is absorbed. In wind power systems in particular a connection between cables can take place at a section limit. A pre-assembled cable in a section can be designed such that at the section limit it is provided with the pin according to the subject-matter and an opposing cable of the other section with the receptacle according to the subject-matter. The engineer then merely has to slide the pin into the receptacle, so that the cables are connected both electrically and mechanically. The self-locking of the pin in the receptacle means that the cables inserted into one another, can no longer be separated from one another because of their own weight force. This means that the connection according to the subject-matter is friction-locked, wherein the retention force is greater than the tensile force caused by the weight force of the cable. The weight force can be the weight of the cable from the section limit as far as its first anchorage point within the section. This weight of the cable section exerts a tensile force on the plug connection between receptacle and pin.

It is also possible for the pre-assembled cables to be cut to length in the respective sections shortly before the section limit and provided either with a receptacle or a pin. Then the section limit can be bridged with a connecting cable having connectors that are complementary to the preassembled cable at the respective section limits. The engineer then simply has to slide the connecting cable into the receptacle or insert the pin of the respective cable end of the preassembled cable to thereby obtain a mechanical and electrical connection between the cables.

According to an embodiment it is also proposed that the second connector is a cone that is self-locking in the receptacle, wherein in particular the receptacle tapers in the insertion direction of the cone. The cone is preferably a cylindrical cone, the angle of inclination of which is designed so that it is disposed in the receptacle in a self-locking manner. The receptacle is preferably a cylinder that is complementary to the cone.

Because the receptacle is designed as a cone, the angle of the cables to one another is not important, making cable assembly easier. The engineer simply has to slide the cone into the receptacle and push it into position. The cables are then mechanically and electrically connected to one another.

The diameter of the connectors can correspond approximately to the cable diameter. It is also possible, however, in a multi-phase connection system for each phase to be fitted with connectors of different diameters or different shapes. Thus for example in a 3-phase system each phase can be associated with a pin-receptacle pairing of different diameters. In wind power systems in particular, for each phase between three and seven cables are used, so that between nine and 21 cables per section are preassembled. These cables must be connected with the respective cables of the other sections with the correct phase. In order to avoid wrong connections, each phase can be fitted with its own connector pairing, wherein the connectors of the individual phases do not complement each other and do not fit one another. The engineer can then carry out assembly without fear of connecting the wrong phases together. It is ensured that electrical contact of the cables that correspond with each other also takes place.

Where aluminium cables are used, it is preferable for the connectors to also be made from aluminium. The advantage of this is that no contact resistances or contact corrosion at the transitions between the cables and connectors results. In order to prevent aluminium oxide forming on the surface of the connectors, it is proposed that the surface of the connectors is tin-plated. It is also possible for the surface to first be nickel-plated and then tin-plated. The nickel substrate provides a durable coating and the tin-plating allows low contact resistance to be achieved.

In order to connect the connectors securely with the cables, it is proposed that a cable end stripped of insulation is disposed in a sleeve. The sleeve can then be pressed around the cable ends such that the individual strands or wires of the stripped cable are clamped securely. Then the front end of the sleeve can be cut or milled off, so that the cable ends end at the front end of the sleeve and are free from aluminium oxide. The connector, which can have a front turned towards the cable end, is welded with the sleeve and the cable end along the front face. Here for example friction welding, especially rotary friction welding can be applied. It is also possible for ultrasound welding or resistance welding to be used, in order to weld the connectors to the sleeve and the cable ends.

In order to create a connection in a single material, it is also proposed that the sleeve is made from aluminium.

Here the sleeve can also be tin-plated and/or nickel-plated, as described above.

A particularly high electrical conductivity is achieved with the use of aluminium cables, if these are of high purity. The use of Al 99.5 in particular has proven to be advantageous. The use of higher- or lower-grade aluminium is also possible, however.

In order to simplify assembly, the aluminium cables, which have a large cable section, should be as flexible as possible. For this reason it is also proposed that the aluminium cables are made from annealed aluminium. This allows the cables, in particular the connectors disposed at the cable ends, to move particularly easily and thus to be connected and pushed together.

In order to prevent the mechanical connection between the cables from coming apart, it is proposed that an insulation sleeve surrounds the connectors. The insulation sleeve prevents environmental influences affecting the electrical connection of the connectors. The insulation sleeve can be designed in such a way that it seals the electrical connection of the connectors so that moisture cannot reach the electrical connection. To that end it is possible for example for the insulation sleeve to bear on the insulation of the cable in the area of the cable end in a moisture-proof manner. This can be achieved, for example, by using an O-ring. It is also possible for heat-shrinkable tubing to be positioned around the insulation sleeve and shrunk onto the insulation of the cable.

Particularly advantageously the insulation sleeve comes in two parts. In this case it is for example possible for a first part of the insulation sleeve o be pushed onto the first cable and then the first connector to be disposed on the first cable. A second part of the insulation sleeve can be disposed on the second cable and then the connector can likewise be disposed on the second cable. Then the two parts can be mechanically and captively joined together. This can take place, for example, by sliding the two parts over one another and then locking or screwing them in place. This can for example take place by rotating the two parts appropriately against each other.

If the two parts are mechanically joined together, it is possible for these to exert an axial compressive force on the connectors such that the connectors are pushed together axially. Such a force can for example be exerted by an annual shoulder provided in the insulation sleeve. The annular shoulder can be formed in such a way that upon joining the parts it pushes against collars disposed on, preferably around, the connectors. When the two parts are mechanically joined together these can for example be moved axially towards each other leading to the annular shoulders pushing against the collars and pushing the connectors together. This creates a mechanical fastening between the connectors beyond their self-locking.

If the two parts of the insulation sleeve are connected together, then the cables are also connected together captively. Even a tensile force exerted on the cables does not lead to the mechanical separation of the connectors from one another. The tensile force would be absorbed by the insulation sleeve, in particular by the collars and the annular shoulders and have no effect on the joining of the connectors.

As already explained above, in the past the assembly of the individual cables at the section limits has been time-consuming and complicated. In order to allow a particularly simple assembly, the engineer must be able to perform the assembly with the minimum use of tools. To allow this, it is also proposed that on at least one part a locknut is disposed to accommodate a hook wrench, wherein by means of the locknut the first part can be screwed together with the second part. The first part can be provided with an external thread and the second part with an internal thread disposed on a locknut. The locknuts can be disposed on the second part so that they rotate about the longitudinal axis and can be rotated by the hook wrench.

In order to screw the parts of the insulation sleeve together, the locknut is pushed onto the external thread and screwed down. In order to achieve a sufficiently high tightening torque during screwing down the last turns can be performed by the hook wrench. The locknut can be mounted using an O-ring so that it can rotate in the part, thus preventing the ingress of moisture into the inside of the insulation sleeve via the locknut.

According to an embodiment it is proposed that the cables are part of an energy lead harness of a wind power system. The electrical connection system is in particular suited for the connection of cables across section limits. The electrical connection system is also suited to the prefabrication of the cables disposed in the respective sections.

A further aspect is a method according to claim 10.

Here it is proposed that the cables are secured together in such a way that a bolt at one end of a first cable by means of self-locking is introduced into a receptacle at one end of a second cable, so that the cables are joined together with a friction lock. In this case the engineer simply has to plug the two cables together thereby creating both a mechanical and an electrical connection. The mechanical connection is secure enough that it can absorb the tensile forces acting on the connection through the weight of the cables themselves.

For greater stability it is proposed that then an insulation sleeve is disposed on the connection, which can absorb further tensile forces.

In the following the invention is explained in more detail by means of a drawing of an exemplary embodiment. The drawing shows as follows:

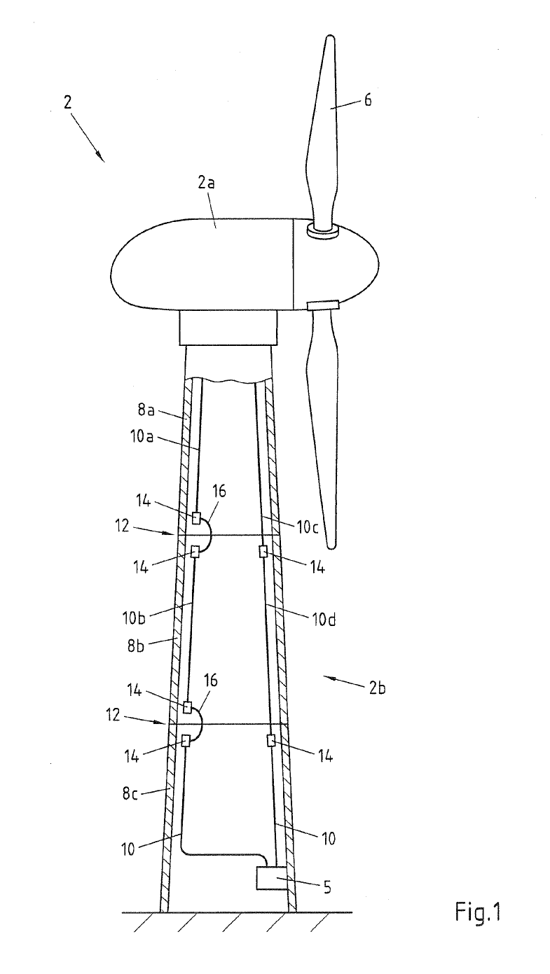

FIG. 1 a wind power system with connections according to the invention;

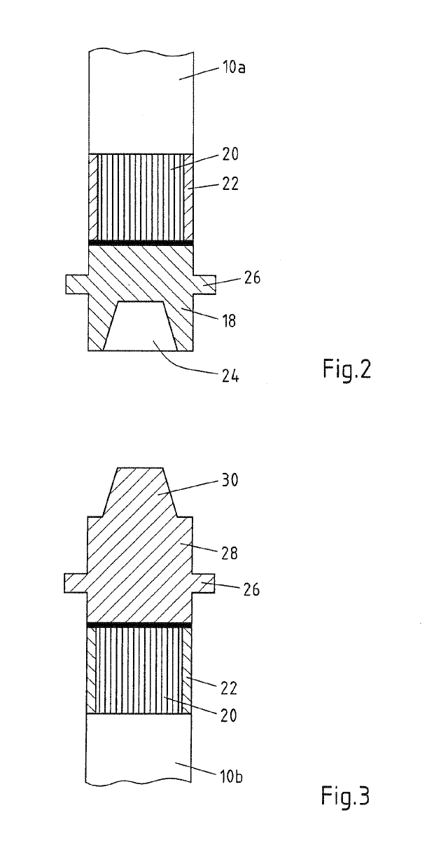

FIG. 2 a cable end with a receptacle;

FIG. 3 a cable end with a cone;

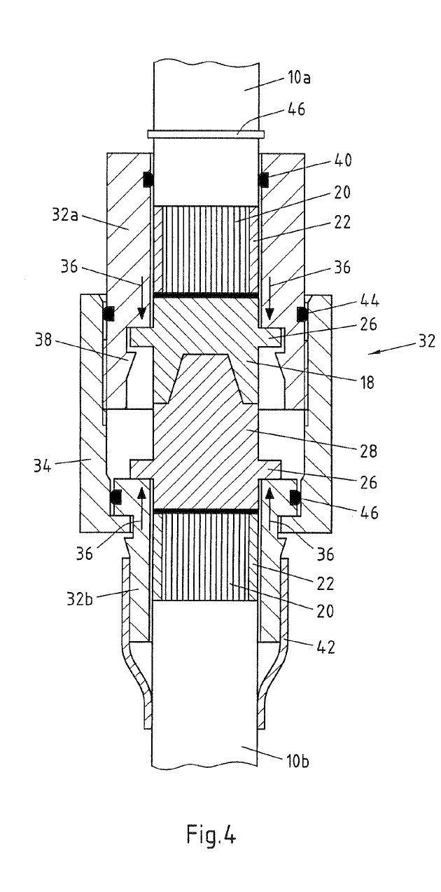

FIG. 4 a connection between two cable ends.

FIG. 1 shows a wind power system 2 with a nacelle 2a and a wind turbine 6. The nacelle 2a is rotatably mounted on a tower 2b forming sections 8a, 8b, 8c. In each of the sections 8a-c a cable harness 10 is disposed, via which the electrical energy from the generator (not shown) disposed in the nacelle 2a is passed to the converter 5 disposed in the base of the tower 2.

The cable harnesses 10 are shown by way of example. Thus in the section 8a for example a cable harness 10a and a cable harness 10c are disposed. For each phase a plurality of cable harnesses 10 can be provided, so that it is quite possible that in a section 8a for each phase three cable harnesses 10a may be provided. In a section 8b the respective cables 10b, 10d are also provided. In the section 8c further cable harnesses 10 are provided.

For the assembly of a wind power system 2 the sections 8 are delivered prefabricated with cables 10. The cables 10 are already contained in the sections 8 when assembly commences and must be mechanically and electrically connected together at the section limits 12. The cables 10 are connected together by means of the connection system 14, as described in more detail below.

On the one hand it is possible that before the section limit 12 the cables 10a, 10b are cut to length and in each case joined to a connector. A bridging cable 16 can connect the cables 10a, 10b across the section limit 12. The bridging cable 16 can have connectors that complement the connectors disposed at each of the cable ends.

On the other hand it is possible for a first cable 10c to have a first connector and a second cable led 10d have a second connector complementary to this. The cables 10c, 10d can be assembled in such a way that they protrude beyond the section limit 12. During assembly the connection system 14 can be plugged together at the section limit 12, so that the cables 10c and 10d can be directly joined together both mechanically and electrically.

The connecting system 14 can be formed from two connectors which are formed complementarily to one another. A first connector 18 is shown in FIG. 2.

In FIG. 2 a cable end of a cable 10a can be seen, having an end 20 with the insulation stripped. Around the stripped end 20 a sleeve 22 is positioned. The cable 10a preferably is made of aluminium strands or wires which are compressed by the sleeve 22, also made from aluminium. To this end the sleeve 22 can be clamped onto the strands. Then the sleeve 22 together with the strands 20 can be ground, trimmed or milled off at the front end. The front face formed in this way can then be connected with the front face of the connector 18 by means of rotary friction welding for a material bond.

The connector 18 is preferably made from aluminium. Both the sleeve 22 and the connector 18 can be nickel-plated and tin-plated. When welding the connector 18 with the sleeve 22 and the free ends of the strands 20 the surface coatings are broken open. Any aluminium oxide, which may have formed on the surfaces, is likewise broken open during welding. The result is a single material connection between the strands 20 and the connector 18.

As will be noted, the connector 18 has a receptacle 24, in the form of a tapering cone. The connector 18 also has a surrounding collar 26.

FIG. 3 shows a second connector 28. The second connector 28 is connected in accordance with the above description with a sleeve 22 and the strands 20 of the cable 10b. It will be noted that the second connector 28 has a cone 30, which is complementary to the receptacle 24. The angle of inclination of the cone 30 and also of the receptacle 24, is such that the cone 30 can be retained in a self-locking manner in the receptacle 24.

Like the connector 18, the connector 28 can have a nickel substrate, be tin-plated and made from aluminium. The connector 28 is also surrounded by a collar 26.

To fit the cables 10a, 10b together the connectors 28 and 18 are pushed into one another. This results in self-locking, such that connector 28 is held in the connector 18. A tensile force exerted by the cables 10a, 10b as a result of the weight of the cable themselves can be absorbed by this static friction. This prevents the connectors 18, 28 from coming apart once they have been plugged together.

In order to increase the stability of the connection, an insulation sleeve 32 is slid over the connectors 18, 28 as shown in FIG. 4.

FIG. 4 shows the two cables 10a, 10b with the respective connectors 18, 28. The connectors 18, 28 are plugged together so that a mechanical and electrically conducting connection between the cables 10a, 10b is created.

In order to make this connection secure, the insulation sleeve 32 is provided. The insulation sleeve 32 is formed from two parts 32a, 32b, wherein part 32b also has a locknut 34. The part 32a can for example be pushed onto the cable 10a, before the connector 18 is welded to the cable end of the cable 10a. The part 32b can likewise be slid over the cable 10b, before the connector 28 is secured to the cable 10b. Thus the cables 10a, 10b assembled with the parts 32a, 32b, 34 and the connectors 18, 26 can be disposed in the respective sections 8a, 8b of the wind power system 2.

When assembling the cables 10, the fitter firstly must only slide together the connectors 18, 28 and then join together the parts 32a, 32b, 34 of the insulation sleeve 32. To do this the fitter slides the parts 32a, 32b over one another and screws the parts 32a, 32b together. For this purpose a locknut 34 disposed on the part 32b and rotatable about the longitudinal axis is provided on the part 32b. The locknut 34 has an internal thread and can be rotated with a hook wrench. The locknut 34 is sealed with an O-ring 46.

On one end the part 32a has an external thread, which is complementary to the internal thread of the locknut 34. For assembly the locknut 34 is placed over the external thread of the part 32 and screwed onto this. This causes the parts 32a, 32b to be pulled together, until a force 36 is exerted on the connectors 18, 28. The force 36 is exerted on the connectors 18, 28 by the annular shoulders, positioned on the insides, of the parts 32a, 32b on the surrounding collars 26.

As will be noted, the annular shoulders of the parts 32a, 32b bear directly on the surrounding collars 26 of the connectors 18, 28. As a result the force 36 impinges on the connection between the connectors 18, 28.

Furthermore, interior lugs 38 can be provided in at least one part of the insulation sleeve 32. The lugs 38 can be designed so that upon connecting the parts 32a, 32b together they can be guided via a collar 26 and then engage behind a collar 26. As soon as the parts 32a, 32b are unscrewed from one another, for example when the locknut 34 is slackened from the part 32a, the lugs 38 engaging behind exert a tensile force against the force 32 on the collar 26. This means that the retention force resulting from the self-locking between the connectors 18, 28 is overcome and the connectors 18, 28 come apart from one another.

In order to prevent the ingress of moisture into the connection point between the connectors 18, 28, an O-ring 40 can for example be provided, which seals the inner wall of the insulation sleeve 32 against the insulation of the cable 10a. It is also possible for a heat-shrinkable tube 42 to be slid over a part of the insulation sleeve 32 and a part of the cable and shrunk onto this. This also prevents moisture entering the area of the connection between the connectors 18, 28. The heat-shrinkable tube 42 can also be slid over the entire insulation sleeve 32.

It is also possible that in the area of the connection between the locknut 34 and the external thread of the part 32a a further O-ring 44 is provided. This O-ring 44 prevents the ingress of moisture via the thread into the area of the connection point between the connectors 18, 28.

Finally, it is also possible that alternatively or additionally to the lugs 38, a fastening ring 46 (circlip) is secured to the insulation of the cable 10a. In the event of the parts 32a, 32b coming apart this ring 46 causes the insulation sleeve to press against the fastening ring 46 and to exert a tensile force on the connection between the connectors 18, 28, so that their self-locking is overcome.

With the aid of the connecting system that has been demonstrated it is possible to connect together in a particularly simple manner cables made from aluminium in wind power systems. The assembly effort is considerably reduced. The contact resistance between the cables is kept low, so that electric losses are minimised. For maintenance purposes the cables can be separated in a particularly simple manner with durability of the connection being ensured.

1-8. (canceled)

9. Electrical connection system of an energy generation device comprising:
a first connector disposed at one end of a first cable;
a second connector disposed at one end of a second cable or a second end of the first cable and that is complementary to the first connector, wherein the first connector has a receptacle for the second connector and the second connector has a bolt to be disposed in the receptacle in a self-locking manner;
a two-part insulation sleeve surrounding the connectors, wherein a first part is disposed on the first cable and a second part is disposed on the second cable and wherein the parts can be mechanically and captively joined together, such that in the connected state a force exerted by the parts on the connectors pushes the connectors axially towards each other.

10. Electrical connection system of claim 9, wherein the second connector is a cone that is self-locking in the receptacle, wherein the receptacle tapers in the insertion direction of the cone.

11. Electrical connection system of claim 9, wherein the first and the second connectors are made of aluminum and in particular are nickel-plated and/or tin-plated.

12. Electrical connection system of claim 9, wherein a cable end stripped of insulation is disposed in a sleeve and in that a front end of the sleeve and/or of the cable end is welded to the connector, wherein the sleeve is made from aluminum.

13. Electrical connection system of claim 9, wherein the cable is made from aluminum, in particular from AL99.5.

14. Electrical connection system of claim 9, wherein on at least one part of the insulation sleeve a locknut is disposed to accommodate a hook wrench, wherein by means of the locknut the first part of the insulation sleeve can be screwed together with the second part of the insulation sleeve.

15. Electrical connection system of claim 9, wherein the cables are part of an energy lead harness of a wind power system.

16. Method for securing cables in an electrical connection system of claim 9, in particular in wind power systems, in which a bolt at one end of a first cable is located in a receptacle at one end of a second cable in a self-locking manner, so that the cables are joined together with a friction lock,
a two-part insulation sleeve surrounds the connectors, wherein a first part is disposed on the first cable and a second part is disposed on the second cable and wherein the parts are mechanically and captively joined together, such that in the connected state a force exerted by the parts on the connectors pushes the connectors axially towards each other.
